(19) United States
(12) Patent Application Publication
(10) Pub. No.: US 2009/0301380 A1
(43) Pub. Date: Dec. 10, 2009

(54) Tachograph for a Motor Vehicle

(75) Inventor: Torsten Wahler, Bad Durrheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/308,007

(22) PCT Filed: May 15, 2007
(86) PCT No.: PCT/EP2007/054676

§ 371 Date: Dec. 4, 2008

(30) Foreign Application Priority Data
Jun. 6, 2006 (DE) 10 2006 026 222.0

(51) Int. Cl. G01P 1/08

(52) U.S. Cl. 116/62.1

(57) ABSTRACT

In a tachograph for a motor vehicle, an electrical line for connecting two electronic subassemblies is routed to form a loop and has respective run-off edges between the loop and the electronic subassemblies. Moisture which condenses on the electrical line is passed from the loop to the run-off edges and can drip off. Damage to the electrical subassemblies is thus avoided.

The invention relates to a tachograph for a motor vehicle, having a first electronic assembly which is arranged in a base part, and having a second electronic assembly which is arranged in a front part, and having an electric cable which connects the electronic assemblies to one another, with the front part being fixed to the base part.

Tachographs of this type have a storage device for a smartcard for storing driver- and vehicle-specific data, operator control elements and a display, and are known in practice. The display and the operator control elements are arranged in the easily accessible front part of the tachograph. These tachographs have to ensure that the components of the front part are supplied with the required operating voltage and with information by a system printed circuit board which is arranged in the base part. Furthermore, it must be possible to fit the front part and the base part to one another. Therefore, in the case of the known tachograph, the cable provided is a flat flexible cable which is inserted into a socket which is arranged on the base part and the front part in each case. When assembling the tachograph, the flat flexible cable is bent such that an upwardly projecting loop is formed.

The known tachographs have the disadvantage that, when moisture enters the tachograph, the moisture can condense on the flat flexible cable. As a result, drops of water are produced which run down the flat flexible cable to the connections of the electronic assemblies. This leads to current bridges between individual contacts of the flat flexible cable and, in an extremely unfavorable case, to breakdown of the tachograph.

It would be possible to provide plug contacts in place of the electric cable between the electronic assemblies. However, this requires particular tolerances between the individual components of the front part and the individual components of the base part and therefore a high level of outlay for manufacture of the tachograph.

It would also be possible the seal off the connections of the electric cable to the electronic assemblies from moisture. This likewise leads to a high level of outlay for manufacture of the tachograph and is also susceptible to faults.

The invention is based on the problem of developing a tachograph of the type mentioned in the introduction such that it can be manufactured in a particularly cost-effective manner and current bridges to the electronic assemblies are reliably avoided.

According to the invention, this problem is solved in that the electric cable has a run-off edge, which points downward in the intended installation position of the tachograph, in front of the connection to at least one of the electronic assemblies.

By virtue of this design, drops of water which condense on the electric cable can run along the cable until they reach the run-off edge. Since the run-off edge points downward in the intended installation position of the tachograph, the drops of water are prevented from reaching the respective electronic assembly. The drops of water can drip off at the run-off edge. Any possible adverse effect on the functioning of the tachograph according to the invention due to current bridges to the electronic assemblies is thus prevented. The tachograph according to the invention therefore does not require any complicated sealing-off or narrow tolerances and can thus be manufactured in a particularly cost-effective manner. The run-off edge is preferably arranged at the lowest point of the cable, so that it is possible to ensure that the drops of water run off completely.

The run-off edge may be, for example, a plastic part which is fixed to the cable. However, a plastic part of this type would be complicated to manufacture and fit. A further contribution is made to reducing the manufacturing costs of the tachograph according to the invention when the run-off edge is formed by a deformed portion of the electric cable. By virtue of this design, the tachograph according to the invention does not require any additional components to prevent current bridges.

According to another advantageous development of the invention, the deformed portion is particularly simple in terms of structure when the deformed portion of the electric cable is of V-shaped design.

According to another advantageous development of the invention, the deformed portion can be produced in a simple manner and kept in its intended position in a reliable manner when the electric cable is in the form of a flat flexible cable with a plurality of individual cable cores and is routed with its plane horizontal to the electronic assemblies.

The electric cable can be fitted in the tachograph according to the invention in a simple manner when the electric cable is routed so as to form a loop in a central region, and when the run-off edge is arranged between the loop and the connection to the electronic assembly. In this case, the loop can be routed upward, so as to save space. The run-off edge is reliably kept close to the respective electronic assembly in the process.

According to another advantageous development of the invention, the electronic assemblies can be particularly reliably protected against the ingress of moisture in a simple manner when the electric cable has a run-off edge close to each of its two ends. When, for structural reasons, it is necessary to protect against moisture only for one of the electronic assemblies, the arrangement of two run-off edges on the electric cable contributes to the direction in which the electric cable is fitted not being important during assembly.

The tachograph according to the invention is of particularly simple construction when the first electronic assembly has a system printed circuit board and the second electronic assembly has a display for displaying data.

The tachograph according to the invention is of particularly compact design when the electronic assembly of the base part has a recess in the region of the run-off edge, and when the electronic assembly of the front part is at a distance from the run-off edge. Furthermore, this design ensures that no water can drip from the cable onto the electrical assembly.

The invention permits numerous embodiments. One of said embodiments is illustrated in the drawing and described below in order to further explain the basic principle of said invention. In the drawings,

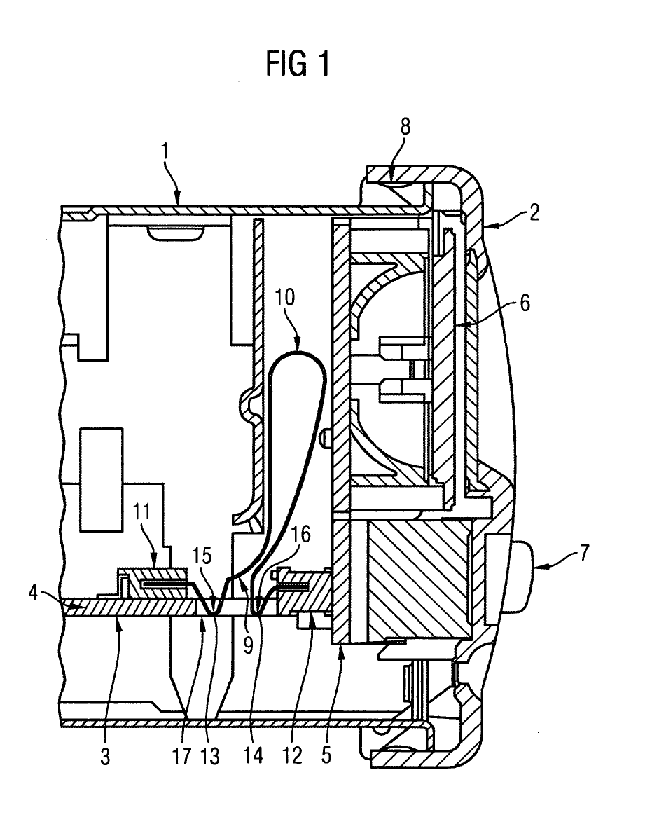

FIG. 1 shows a sectional illustration through a tachograph according to the invention in the assembled state,

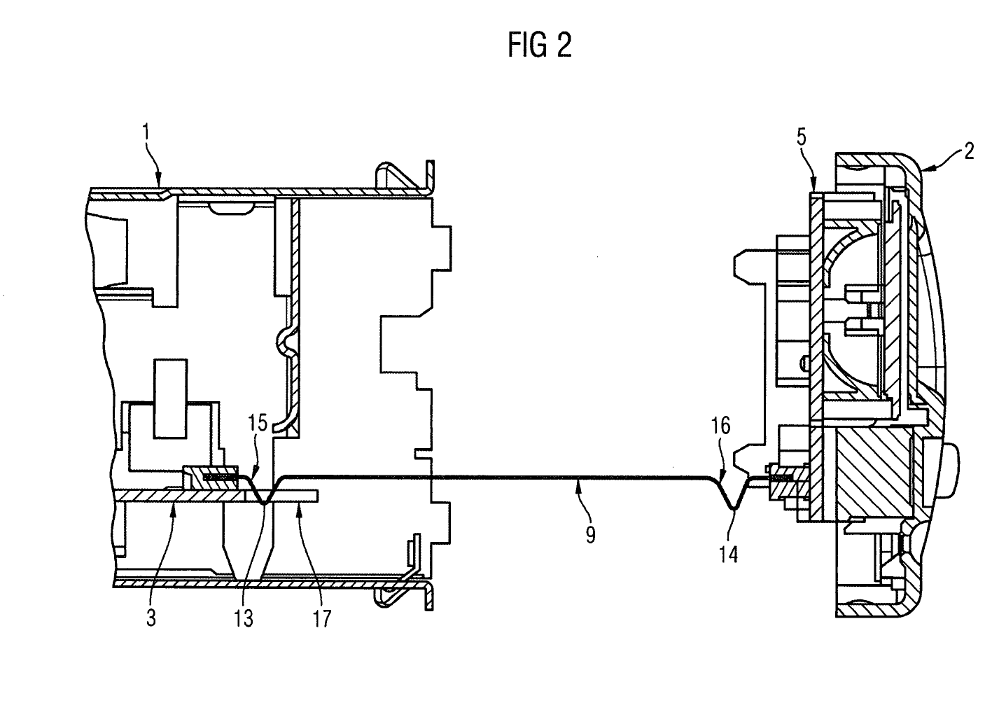

FIG. 2 shows a sectional illustration through the tachograph according to the invention from FIG. 1 before assembly,

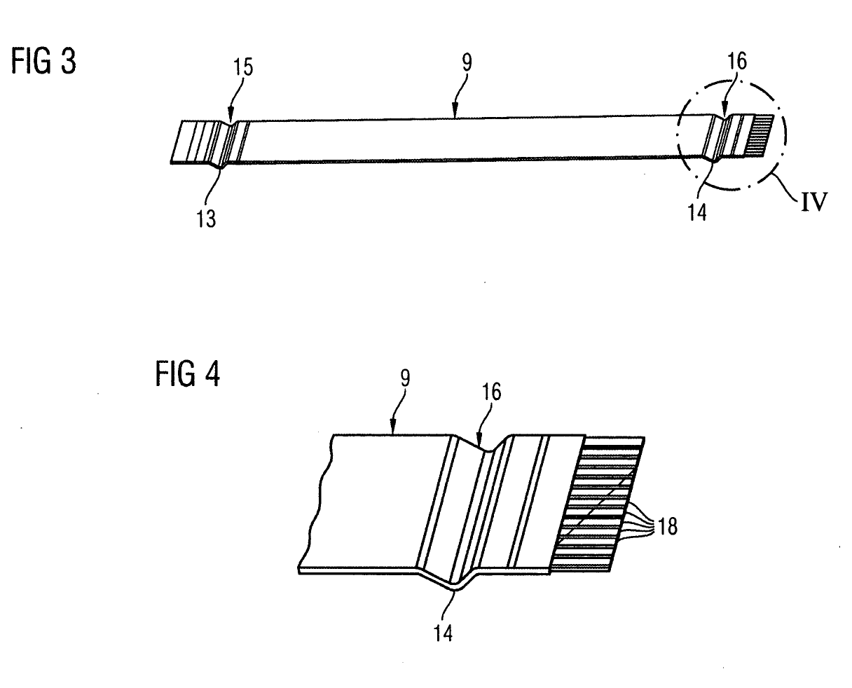

FIG. 3 shows a perspective view of an electric cable of the tachograph according to the invention, which electric cable is in the form of a flat flexible cable,

FIG. 4 shows a greatly enlarged view of subregion IV of the electric cable from FIG. 3, which electric cable is in the form of a flat flexible cable.

FIG. 1 shows a sectional illustration through a tachograph for a motor vehicle, having a base part 1 and having a front part 2. The tachograph is illustrated in the intended installation position. The base part 1 has a first electronic assembly 3 with a system printed circuit board 4. The first electronic assembly 3 serves, for example, to record driver- and vehicle-specific data, to actuate a printer (not illustrated) and a storage device for a smartcard (likewise not illustrated). The front part 2 has a second electronic assembly 5 with a display 6 for displaying data, and operator control elements 7 for programming the tachograph. The front part 2 is held on the base part 1 by a latching connection 8. The electronic assemblies 3, 5 are connected to one another via a cable 9 which is in the form of a flat flexible cable. The electric cable 9 has an upwardly pointing loop 10 and is attached to connections 11, 12 of the electronic assemblies 3, 5. The electric cable 9 has a downwardly pointing run-off edge 13, 14 between the loop 10 and each of the connections 11, 12. The run-off edges 13, 14 are formed by deformed portions 15, 16 of the electric cable 9 and project through a recess 17 in the first electronic assembly 3. The second electronic assembly 5 is at a distance from the deformed portions 15, 16 with the run-off edges 13, 14.

When moisture condenses on the cable 9, drops of water which run downward can form, in particular, on the loop 10 of the electric cable 9. In this case, the drops of water are routed from the deformed portions 15, 16 to the run-off edges 13, 14 and drip through the recess 17 in the electronic assembly 3 of the base part 1, past the two electronic assemblies 3, 5. Damage to the electronic assemblies 3, 5 due to current bridges produced by drops of water is thus prevented.

FIG. 2 shows, for explanation purposes, the tachograph from FIG. 1 before assembly. This figure shows that the front part 2 is at a distance from the base part 1. The electric cable 9 is stretched between the electronic assemblies 3, 5 in this case. The front part 2 is moved toward the base part 1 for the purpose of assembling the tachograph. In the process, the loop 10 is produced between the two deformed portions 15, 16, as illustrated in FIG. 1.

FIG. 3 shows a perspective view of the cable 9, which is in the form of a flat flexible cable, before it is fitted to the connections 11, 12 of the electronic assemblies 3, 5 illustrated in FIGS. 1 and 2. One end of the electric cable 9, which end is denoted IV, is illustrated on a greatly enlarged scale in FIG. 4. This figure shows that the cable 9, which is in the form of a flat flexible cable, has a plurality of individual cable cores 18 which are arranged next to one another. The individual cable cores 18 are routed in a plane horizontal to the connections 11, 12 illustrated in FIGS. 1 and 2. The deformed portions 15, 16 with the run-off edges 13, 14 are bent out of the plane.

1.-8. (canceled)

9. A tachograph for a motor vehicle, the tachograph comprising:
a first electronic assembly arranged in a base part;
a second electronic assembly arranged in a front part, the front part being removeably mounted to the base part; and
an electric cable adapted to couple the first electronic assembly to the second electronic assembly, wherein the electric cable has at least one run-off edge that points downward in the intended installation position of the tachograph between the first electronic assembly and the second electronic assembly.

10. The tachograph according to claim 9, wherein the at least one run-off edge is formed by a deformed portion of the electric cable.

11. The tachograph according to claim 10, wherein the deformed portion of the electric cable is V-shaped.

12. The tachograph according to claim 10, wherein the electric cable is a flat flexible cable with a plurality of individual cable cores, the flat flexible cable being routed with its plane horizontal to the electronic assemblies.

13. The tachograph according to claim 10, wherein the electric cable is routed to form a loop in a central region of the flat flexible cable, and wherein the at least one run-off edge is arranged between the loop and a connection of the flat flexible cable to at least one of the first electronic assembly and the second electronic assembly.

14. New) The tachograph according to claim 10, wherein the electric cable has the at least one run-off edge at a first end of the flat flexible cable and a second run-off edge at a second end of the flat flexible cable.

15. The tachograph according to claim 14, wherein the first electronic assembly comprises a system printed circuit board and the second electronic assembly comprises a display for displaying data.

16. The tachograph according to claim 11, wherein the first electronic assembly comprises a recess a region of the at least one run-off edge, and wherein the second electronic assembly is at a distance from the at least one run-off edge.

17. The tachograph according to claim 13, wherein the electric cable has a second run-off edge arranged between the loop and a connection of the flat flexible cable to the other of the first electronic assembly and the second electronic assembly.

18. A tachograph for a motor vehicle, the tachograph comprising:
a base portion;
a first electronic component mounted in the base portion;
a first electrical connector arranged on the first electrical component;
a front portion being removeably mounted to the base portion;
a second electronic assembly arranged in the front portion;
a second electrical connector arranged on the second electrical component; and
an electric cable adapted to electrically couple the first electronic assembly to the second electronic assembly via a first end of the electrical cable coupled to the first electrical connector cable routed to form an arch-like region between the first and the second end of the electric cable,
wherein the electrical cable has a first run-off edge between the arch-like region and the first electrical connector and a second run-off edge between the arch-like region and the second electrical connector, the first and the second run-off edges point substantially downward when the tachograph is in a mounted position.

19. The tachograph according to claim 18, wherein the first and the second run-off edges are substantially V-shaped.

20. The tachograph according to claim 19, wherein the electrical cable is a flat ribbon cable having a plurality of substantially parallel conductors.

21. The tachograph according to claim 18, further comprising a third run-off edge between the arch-like region and one of the first and the second electrical connectors.
